(19) United States
(12) Patent Application Publication
(10) Pub. No.: US 2023/0177542 A1
(43) Pub. Date: Jun. 8, 2023

(54) MACHINE-IMPLEMENTED ANALYTICAL MODEL FOR GROUP BENEFITS GROWTH SCORE

(71) Applicant: PRINCIPAL FINANCIAL SERVICES, INC., Des Moines, IA (US)

(72) Inventors: Joel Rosenberg, Des Moines, IA (US); Cory Knepper, Ankeny, IA (US); Peter Larson, Des Moines, IA (US)

(73) Assignee: PRINCIPAL FINANCIAL SERVICES, INC., Des Moines, IA (US)

(21) Appl. No.: 17/542,953

(22) Filed: Dec. 6, 2021

(51) Int. Cl. G06Q 30/02; G06Q 10/06

(52) U.S. Cl. CPC G06Q 30/0205; G06Q 10/06315; G06Q 30/0207

(57) ABSTRACT

A method, system, and process for predicting growth for group benefits usage where data is received at a processor of a computing device and from at least one external data source connected over a communications network with the computing device, data for populating one or more of the set of variables for each of the plurality of companies. The method includes receiving at the processor of the computing device and from at least one internal data source in operative communication with the computing device, data for populating one more additional variable within the set of variables for each of the plurality of companies and executing the instructions for implementing the scoring model to apply the scoring model to evaluate the plurality of companies using the processor of the computing device in order to generate the single score indicative of growth for each of the plurality of companies.

### FIELD OF THE INVENTION

The present invention relates to data processing systems, and in one particular example, to analytical techniques for prediction and classification of growth or decline in employee numbers for small and medium businesses which are customers for group benefits products.

### BACKGROUND

Group benefits products including any number of financial and insurance products which an employer may offer to its employees. Group benefits may be funded in whole or in part by the employer or in whole or in part by the employees. Examples of group benefits products include, without limitation, group insurance such as group disability insurance, group life insurance, group dental insurance, group vision insurance, group critical illness insurance, group accident insurance, retirement plans such as 401(k) or 401(b) plans, and other types of group benefits.

Customer segmentation allows for a business to better understand customers and potential customers. However, generally customer segmentation is based on historical or current data about customers or potential customers. It would be advantageous to predict the future needs for customers or potential needs. For example, if growth and profitability associated with different specific customers of group benefits products can be identified then those customers may be offered incentives such as two-year rate guarantees on pricing. Or alternatively, marketing efforts such as paid advertising may be focused on engagement with identified medium and/or high growth customers.

Despite the potential benefit of being able to predict the future needs of customers, doing so presents a number of data analytics problems which would need to be overcome. There are no known data sources available that predict employee growth on an individual business level. Available forecast data is typically based on industry and/or geographic region which limits its usefulness and makes insufficient to provide accurate predictions for individual businesses. Moreover, there are no known studies which have identified specific variables for determining employment growth for small and medium businesses purchasing group benefit products, let alone specific models for making such predictions.

Therefore, what is needed are methods, apparatuses, and or systems which allow for analytically predicting and classifying employee growth especially for small and medium-sized companies who offer group benefits products to their employees.

### SUMMARY

Therefore, it is a primary object, feature, or advantage of the present invention to improve over the state of the art.

It is another object, feature, or advantage to provide for analytically predicting and classifying employee growth especially for small and medium-sized companies.

It is a further object, feature, or advantage of the present invention to provide methods and systems for characterizing case size growth (employee lives) in the next 3-5 years.

It is a still further object, feature, or advantage to identify group benefits employers who are customers or potential customers who are high growth and may result in high profitability.

It is another object, feature, or advantage to reward and retain group benefits employer customers who are high growth and high profitability such as by providing a rate-guarantee on the pricing they pay for group benefits products.

It is yet another object, feature, or advantage to leverage data indicative of growth for small and medium size businesses in order to increase reach and engagement with medium and high growth customers.

A further object, feature, or advantage is to provide for employment growth prediction on an individual, company by company basis as opposed to by industry and/or geographic location.

It is a still further object, feature, or advantage of the present invention to identify and rank customers most likely to grow in order to allow for more personalized and impactful retention efforts.

Another object, feature, or advantage is to identify groups which exhibit high employment growth potential over the medium term.

Yet another object, feature, or advantage is to provide objective analysis which may be used to drive resource allocation for customer acquisition efforts.

A further object, feature, or advantage is to provide objective analysis which may be used to drive resource allocation for customer retention.

Yet another object, feature, or advantage is providing a score for each business as to their medium-term expected growth potential for group benefits usage.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by any objects, features, or advantages stated herein.

One aspect of the present disclosure relates to a system. The system includes one or more hardware processors configured by machine-readable instructions to implement a scoring model, the scoring model constructed by: identifying a set of variables, for each of the set of variables assigning a scoring range, the scoring range having a high value and a low value, for each of the set of variables, identifying segments of scores within the scoring range and a score for each of the segments, for each of a plurality of organizations assigning a score for each of the set of variables within the scoring range, and generating a composite score based on the score for each of the set of variables, wherein the composite score combine the score for each of the set of variables into a single score indicative of growth for an individual company. The instructions further receive at the one or more hardware processors a plurality of company identifiers, each of the plurality of the company identifiers associated with a different one of a plurality of companies. The instructions further receive at the one or more hardware processors and from at least one external data source connected over a communications network with the one or more hardware processors, data for populating one or more of the set of variables for each of the plurality of companies. The instructions further receive at the one or more hardware processors and from at least one internal data source in operative communication with the one or more hardware processors, data for populating one more additional variable within the set of variables for each of the plurality of companies. The instructions further apply the scoring model to evaluate the plurality of companies using the one or more hardware processors in order to generate the single score indicative of growth for each of the plurality of companies.

Another aspect of the present disclosure relates to a process for predicting growth. In some embodiments, the process may include identifying a set of variables,
for each of the set of variables assigning a scoring range, the scoring range having a high value and a low value, for each of the set of variables, identifying segments of scores within the scoring range and a score for each of the segments, For each of a plurality of organizations assigning a score for each of the set of variables within the scoring range, and generating a composite score based on the score for each of the set of variables. The composite score combines the score for each of the set of variables into a single score indicative of growth for an individual company. In some embodiments, the process may include storing in a machine readable memory of the computing device a plurality of instructions for implementing the scoring model. In some embodiments, the process may include receiving at the processor of the computing device a plurality of company identifiers, each of the plurality of the company identifiers associated with a different one of a plurality of companies. In some embodiments, the process may include receiving at the processor of the computing device and from at least one external data source connected over a communications network with the computing device, data for populating one or more of the set of variables for each of the plurality of companies. In some embodiments, the process may include receiving at the processor of the computing device and from at least one internal data source in operative communication with the computing device, data for populating one more additional variable within the set of variables for each of the plurality of companies. In some embodiments, the process may include executing the instructions for implementing the scoring model to apply the scoring model to evaluate the plurality of companies using the processor of the computing device in order to generate the single score indicative of growth for each of the plurality of companies.

According to another aspect, a system includes a means for building a scoring model by identifying a set of variables wherein the set of variables comprise a first variable for years in business, a second variable for online status of benefits sign-up, a third variable indicative of number of employees, a fourth variable for number of total products, a fifth variable for forecast growth, and a sixth variable for recent employment growth, for each of the set of variables assigning a scoring range, the scoring range having a high value and a low value, wherein the scoring range for the first variable is −1 to 2, for each of the set of variables, identifying segments of scores within the scoring range and a score for each of the segments, and for each of a plurality of organizations assigning a score for each of the set of variables within the scoring range. The system may further include means for generating a composite score based on the score for each of the set of variables, wherein the composite score combines the score for each of the set of variables into a single score indicative of growth for an individual business for group benefits usage. The system may further include means for storing in a machine readable memory of a computing device a plurality of instructions for implementing the scoring model. The system may further include means for receiving at a processor of the computing device a plurality of business identifiers, each of the plurality of the business identifiers associated with a different one of a plurality of businesses. The system may further include means for receiving at the processor of the computing device and from at least one external data source connected over a communications network with the computing device, data for populating one or more of the set of variables for each of the plurality of businesses. The system may further include means for receiving at the processor of the computing device and from at least one internal data source in operative communication with the computing device, data for populating one more additional variable within the set of variables for each of the plurality of businesses. The system may further include means for executing the instructions for implementing the scoring model to apply the scoring model to evaluate the plurality of businesses using the processor of the computing device in order to generate the single score indicative of growth for each of the plurality of businesses for group benefits usage.

### BRIEF DESCRIPTION OF THE DRAWINGS

Illustrated embodiments of the disclosure are described in detail below with reference to the attached drawing figures, which are incorporated by reference herein.

FIG. 1 is an overview of one example of a system.

FIG. 2 is a flow chart illustrating one method of predicting growth using the system,

FIG. 3 is a flow chart illustrating one method for building a model for predicting growth using the system.

FIG. 4 is a diagram further illustrating a system for predicting growth.

FIG. 5 is a pictorial representation of one example of application of the system to characterize growth of an individual business.

FIG. 6 is a pictorial representation of another example of application of the system to characterize growth of an individual business.

FIG. 7 is a pictorial representation of another example of application of the system to characterize growth of an individual business.

### DETAILED DESCRIPTION

The present disclosure relates to modeling and analysis to predict growth (as measured by number of employees) for small and medium size businesses. For purposes here, when discussing a small or medium business, it is understood that a small and medium business has less than 500 employees, whereas a large business would have 500 or more employees.

According to one embodiment a growth score is determined based on a model configured for characterizing growth for the near term, especially for about the next 3 to about the next 5 years. The growth score measures the likelihood of a given business to experience case size growth (employee lives) in the next 3 to 5 years. Once obtained for a particular business or for each individual business within a set of businesses, the growth score may be utilized in a number of different ways. For example the growth score may be used to identify customers who are high growth and high profit. Where such customers are identified, these customers may be incentivized so as to retain customers.

The growth score is an analytical scoring system which leverages a combination of internal data sources for a specific group benefits employer customer, and external data sources to aggregate data together into a composite score. The score itself measures the likelihood of a given business to experience case size growth (employee lives) in the next 3-5 years.

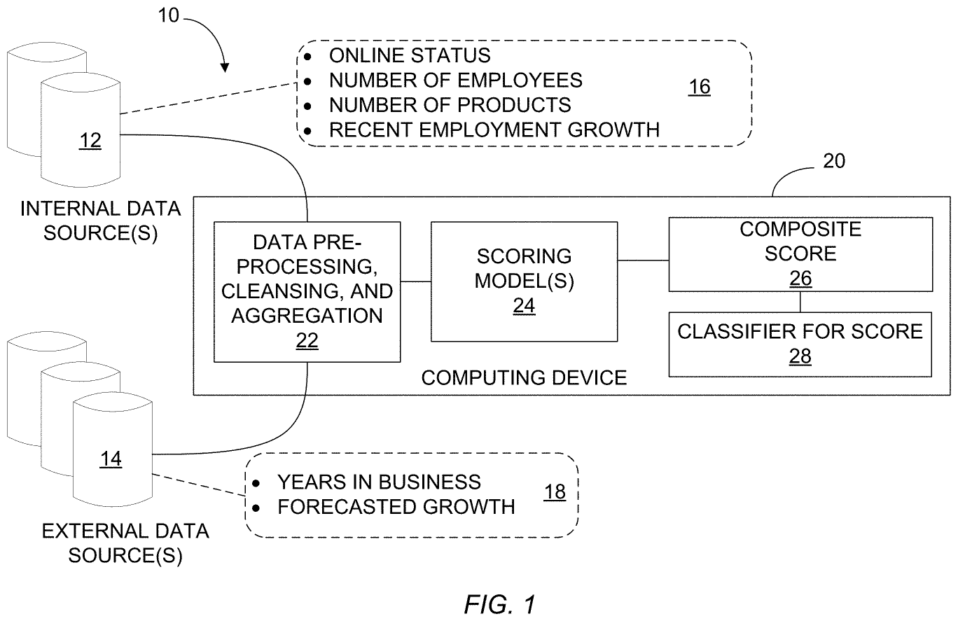

FIG. 1 illustrates an overview of one example of a system. As shown in FIG. 1, the system 10 includes one or more internal data sources 12 and one or more external data sources 14. The data sources may be databases or other types of data stores, data services, or other types of data sources which are in operative communication with a computing device 20. The computing device 20 may include one or more processors and memories for storing instructions. The this may include instructions or modules for data pre-processing, cleansing, and aggregation 22. Because data may be received from internal data sources 12 and external data sources 13, the data may require additional pre-processing, cleansing, and aggregation. Although, depending on the configuration of the model, different data may be obtained. However, in some examples, data from internal data sources may include variables 16 such as online status (e.g. whether or not an employer offers online enrollment for one or more benefits), the number of employees for the business, the number of insurance or financial products the company currently offers to employees, and recent employment growth. In some examples, data from external data sources may include variables 18 such as the number of years in business, and forecasted growth based on type of industry and geographic area. Data sources may be connected in various ways. For example, external data sources may be connected using API connections associated with their providers.

Once the data has been pre-processed, cleansed, and/or aggregated, the data or variables may be received into one or more scoring models 24. As will be explained in more detail, the scoring models 24 receive the data and applying applicable rules, techniques, or methods to generate a single composite score 26 for each business. Based on the composite score 26, a classifier for the score may be assigned such as an indicia whether the expected growth is high, medium, or low. Of course, other appropriate classifiers may be used in addition or alternatively.

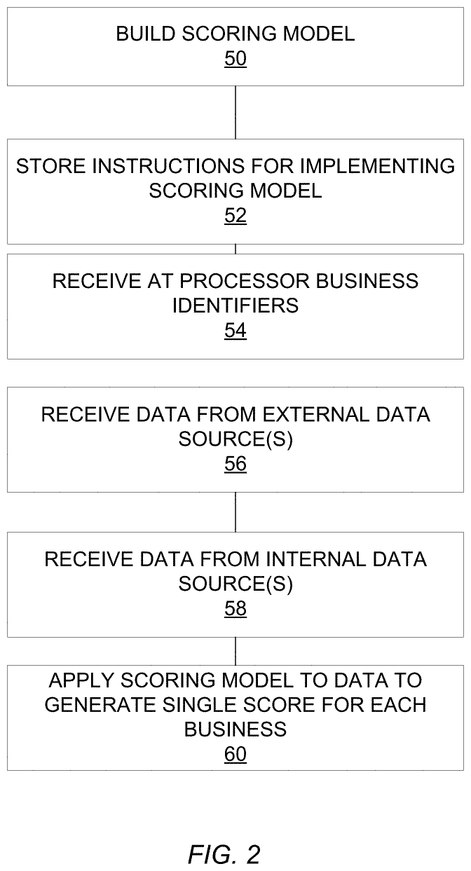

FIG. 2 illustrates one example of a method. In step 50 a scoring model is built. The scoring model may be built in various ways and may take into account any number of different variables which relate to growth for small and medium size businesses. Once the model itself, instructions for implementing the scoring model and applying it may be scored. The instructions may be generated in any number of different languages. For example, the instructions may be implemented using python, R, SAS, C, Java, or other appropriate tools. Once the model is implemented with instructions, then data can be collected. For example, in step 54, business identifiers may be received at a processor executing instructions. The business identifiers provide for uniquely identifying individual business. The individual business identifier may be, for example, a contract identifier. Alternatively, the business identifier may be a government identifier such as a Federal Employer Identification Number. Any number of other identifiers may be used to individually and uniquely identify each business. In step 56, data from one or more external data sources may be received. In step 58 data from one or more internal data sources may be received. Then in step 60, the scoring model is applied using the data in order to generate a single score for each business. After the scoring is performed, various options may be taken. For example, the results may be compiled into a report or presentation. In addition, the scores may be used to classify the level of growth for the different businesses. In addition, the business may be sorted based on the scores or the level of growth. The businesses may also be rank ordered based on the scores.

The method and system are advantageous in that the model allows for large and complicated data sets compiled from multiple disparate data sources including internal and external data sources to be used to obtain a single composite score for each business. Moreover, the model is designed to take as input data which is available from a combination of internal and external data sets, but with a limited number of variables in order to predict growth for individual businesses.

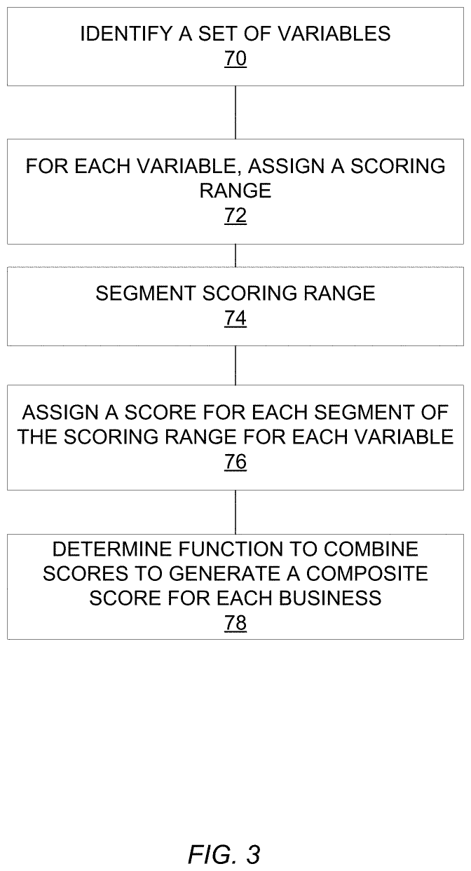

FIG. 3 is a diagram which illustrates one example of constructing or building a scoring model. In step 70 a set of variables is identified. As previously explained, this may include variables both from internal data sources as well as external data sources. These variables may include historic data for a business or industry as well as predicted data for a business or industry. It is preferred that as small of set of variables as possible is selected but which still provides sufficiently accurate results. For example, a variety of feature selection techniques may be used to produce an initial list of variables to test with and then statistical techniques may be further used to evaluate relationships between these variables and historical employment growth. Historical data may be used to evaluate the validity and accuracy of the selection of different variables.

The model may be created in different ways after the variables are defined or concurrently therewith. This may include determining the appropriate weighting for each variable. This may again be performed using statistical techniques which are applied to better understand the contribution of each variable to the overall growth score as well as relationships between the different variables. Next in step 72, for each variable a scoring range is determined. The scoring range has a high value and a low value. In step 74, the scoring range is segmented into two or more segments. In step 76, a score is assigned for each segment of the scoring range for each variable. In step 78, a function is determined to combine the scores to generate a composite for each business. This may involve summing the scores, averaging the scores, or weighting the scores or otherwise applying a function which combines the scores from each variable.

Once the model is generated such as using the methodology shown in FIG. 3, the model can be populated with data input into the system. It is to be understood that in the process of creating the model, statistical analysis may be performed including using univariate and multivariate techniques to determine the variables involved, segmentation, scoring, weighting, and other parameters or aspects of the model.

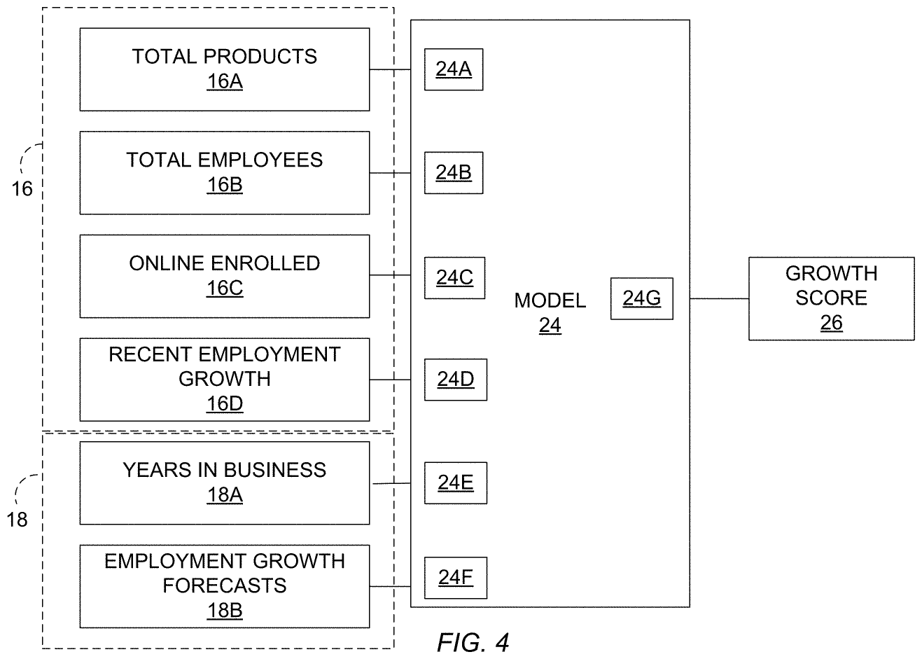

FIG. 4 illustrates another example of an embodiment. As shown in FIG. 4, there is a model 24. The model 24 may be constructed in the manner previously described or otherwise constructed. The model 24 may be implemented in software such as through a series of instructions stored on a machine readable computer readable non-transitory memory which when executed by one or more processors provides for implementing the model. The model 24 receives a plurality of inputs. These include internal data inputs or variables 16 from internal data sources. Examples of such internal data inputs may be total products 16A, total employees 16B, online enrolled 16C, and recent employment growth 16D. Examples of data inputs or variable 18 from external data sources may include years in business 18A and employment growth forecasts 18B. In some embodiments, data is cleaned or otherwise pre-processed before being input into the model 24.

The model may be implemented as a plurality of different modules 24A, 24B, 24C, 24D, 24E, 24F, 24G. The modules 24A-24G may, for example, be software modules which may be implemented as python scripts or otherwise. For example, module 24A may be used to receive as input the total number of products for an individual company and then generate a flag, sub-score, or intermediate score based on the input. Module 24B may be used to receive as input a total number of lives or employees for the individual company and then generate a flag, sub-score, or intermediate score based on the input. Similarly, module 24C may be used to receive as input whether the company provides for online enrollment or note and then generate a flag, sub-score, or intermediate score based on the input. Module 24D may be used to receive as input recent employment growth and generate a flag, sub-score, or intermediate score based on the input. Module 24E may be used to receive as input the number of years in business and then generate a flag, sub-score, or intermediate score based on the input. Module 24F may be used to receive as input employment growth forecasts. Module 24G may perform the function of combining outputs from modules 24A, 24B, 24C, 24D, 24E, and 24F in order to generate the composite growth score 26. It is contemplated that more or fewer modules may be used as may be appropriate for a particular implementation. According to the embodiment shown, the model was constructed with 6 input variables. Various models with different inputs and different numbers of inputs may be used, the final selection of the 6 input variables reflect both internal factors as well as external, forward-looking predictions.

Various external data sources were considered to provide different variables Examples include Dun & Bradstreet in order to provide variables such as case level firmographic data, ownership structure, revenue, square footage, and years in business. FactSet was considered to provide a data aggregation tool for analyzing publicly traded companies and to provide industry revenue growth projections. BLS was considered to provide 10-year employment growth forecasts by industry, updated annually. Moody's Analytics was considered to provide employment growth forecasts out to 30 years for industries at the state, metro, or county level and updates data monthly. Of course, any number of other external data sources may provide the same, similar, or alternative data of potential relevance.

The 6 preferred variables are (1) years in business, (2) online status, (3) case size, (4) total products, (5) forecast growth, and (6) recent employment growth. The employment growth forecast may be determined using Moody's Analytics. The number of years in business may be determined from Dun & Bradstreet.

In addition, the scoring ranges assigned to each variable may vary as well as the weighting of each of the variables. It is contemplated that more or fewer variables may be used provided that the resulting model can be shown to provide similar or improved results.

To further assist in explanation of various embodiments, exemplary input data or variables are discussed below.

The time in business or years in business. For purposes of the model, the number of years in business for a particular organization is determined. Although the time is standardized to years, it is to be understood that it may be otherwise measured such as by months in business. Through analysis of years in business and its effect on growth of a company weightings were determined. The below table illustrates one example of the manner in which the years in business may be scored. Here, if the number of years in business is 0-9 then the trend or rule identified is that there will be more growth in the future. Therefore a “2” is assigned. If the business has existed for 10-19 years, then the trend or rule identified is that there will be growth in the future. Therefore a “1” is assigned. If the business has existed for over 20 years, then the trend or rule identified is that there will be flat growth. Therefore, a “0” is assigned. If data regarding years in business is not available from Dun & Bradstreet or similar sources, then the trend or rule is that there is less growth and a “−1” is assigned.

| Yrs in Business | Trend/Rule | Flag |
|---|---|---|
| 0-9 | More Growth | 2 |
| 10-19 | Growth | 1 |
| 20+ | Flat | 0 |
| Missing (no D&B) | Less Growth | −1 |

Online status. For purposes of the model, a determination is made as to whether the business offers online enrollment for any group benefits product offered to its employees. In other words, the business offers some type of digital connectivity for benefits. If the business does not offer any type of online enrollment for group benefits, then the general trend or rule is that growth will be flat for the business. Therefore a “0” is assigned. If the business offers online enrollment for one or more group benefits products, then the general trend or rule is that there will be more growth for the business. Therefore a “2” is assigned.

| Online Status | Trend/Rule | Flag |
|---|---|---|
| No Online | Flat | 0 |
| Any Online | More Growth | 2 |

Case size. For purposes of the model a determination in made as to the case size. The case size is the number of employees for the business. If the case size is 1-9 employees then the general trend or rule is that less growth is expected. Therefore a “−1” is assigned. If the case size is 10-49 employees, then the general trend or rule is considered to be flat. Therefore a “0” is assigned. If the case size is 50 employees or greater then growth is expected. Therefore a “1” is assigned.

| Case Size | Trend/Rule | Flag |
|---|---|---|
| 1-9 | Less Growth | −1 |
| 10-49 | Flat | 0 |
| 50+ | Growth | 1 |

Total products. For purposes of this model, a determination is made as to the number of products for the company. The number of products is the number of pension or insurance products of the company. If there is only a single product, then the general trend or rule is that less growth is expected. Therefore a “−1” is assigned. If there are 2 products, then the general trend or rule is that growth is flat. Therefore a “0” is assigned. If there are 3 to 4 products assigned, then the general trend or rule is that there is growth. Therefore a “1” is assigned. If there are 5 total products, then the general trend or rule is that there is more growth. Therefore a “2” is assigned. If there are 6 or more products, then the general trend or rule is that there is substantially more growth. Therefore a “3” is assigned.

| Total Prods | Trend/Rule | Flag |
|---|---|---|
| 1 | Less Growth | −1 |
| 2 | Flat | 0 |
| 3-4 | Growth | 1 |
| 5 | More Growth | 2 |
| 6+ | Substantially more | 3 |
| | growth | |

Forecast growth. For purposes of this model, the employment growth forecast is taken into account. This may be, for example, a 3 year employment forecast growth change or a 5 year employment forecast growth change. The forecast growth may be obtained for the industry and geographical area(s) (e.g. city) for the business. NAICS (North American Industry Classification System) codes or Standard Industrial Classification (SIC) codes may be used to specify an industry and a CBSA (Core Based Statistical Areas) may be used to specify a locale. This forecast growth may be for a 3 year time period, a 5 year time period, or other time period. This may be obtained from Moody's or other data sources. If there is high growth forecast such as greater than 10 percent than a “6” is assigned. If there is a medium level of growth such as 5 to 10 percent growth, then a “3” is assigned. If there is low growth forecast such as 0 to 5 percent growth, then a “0” is assigned. If the company is in decline, then a “0” is assigned. Note that is a forward-looking projection but is not specific to an individual business.

| Forecast Growth | Trend | Flag |
|---|---|---|
| H | >10% | 6 |
| M | 5-10% | 3 |
| L | 0-5% | 0 |
| D | Declining | −3 |

Recent growth. For purposes of this model, the recent growth is taken into consideration. If there is high growth, with a trend of greater than one, then a “2” is assigned. If there is a trend of growth with zero to one, then a “1” is assigned. If there is no growth, then a “0” is assigned. If there is declining growth in the range of −1 to 0 then a “−1” is assigned. If the decline is greater such as less than a −1, then a “−2” is assigned. Recent growth may be for a given lookback time period such as within the last calendar quarter, although any number of other time periods may be used. Recent growth may then be calculated as a percentage of employee lives increased or decreased during the lookback period. Thus, for example, a recent growth rate of 1.0 would indicate a 100 percent increase in employees within the last quarter.

| Recent Growth | Trend | Flag |
|---|---|---|
| High Growth | >1 | 2 |
| Growth | 0 to 1 | 1 |
| No Growth | 0 | 0 |
| Declining | −1 to 0 | −1 |
| More Declining | <−1 | −2 |

Once the flags, sub-scores, or values are obtained for each of the 6 factors, each of these scores may be combined such as by adding together to determine a single composite score. In analysis with over 100,000 companies for a 3 year forecast, the range for the composite score went from a low of −6 to a high of 16. Composite scores of 0 or under were considered to be indicative of no growth. Scores between 1 to 6 were considered to be growth, and scores of 7 and above were considered to show high growth. In an analysis of over 100,000 companies for a 5 year forecast, the range for the composite scores varied between −8 and 16.

Having a single composite score allows for rank ordering of companies based on growth potential despite the fact that the companies may be from diverse locations, diverse industries, have major variance in the number of employees and other differences. Thus, not only is a growth projection for individual companies provided, but it is performed in a manner that allows for a comparison of growth potential across different businesses from different geographies and industries. It is to be further understood that the single composite score captures potential growth of employee usage of group benefits products.

Once obtained for an individual company the growth score may be used in various ways. For example, if the individual company is a prospective customer than the growth score may be used as a part of the sales process. For example, the growth score may be used in an algorithm which provides an expected value model. The expected value model may provide output useful when quoting contract costs for new customers. In one embodiment, a determination of an expected value of a contract in an initial time period may be determined and then the expected value of the contract in subsequent time periods may be computed using the growth score to increase or decrease the expected value based on growth. Once the expected value is obtained it may be used in advertising and marketing efforts as well to provide more targeted outreach to prospects or customers.

In addition, once obtained, the growth score for each company may also be periodically re-calculated or updated. For example, the growth score may be updated on a quarterly basis or other appropriate time period.

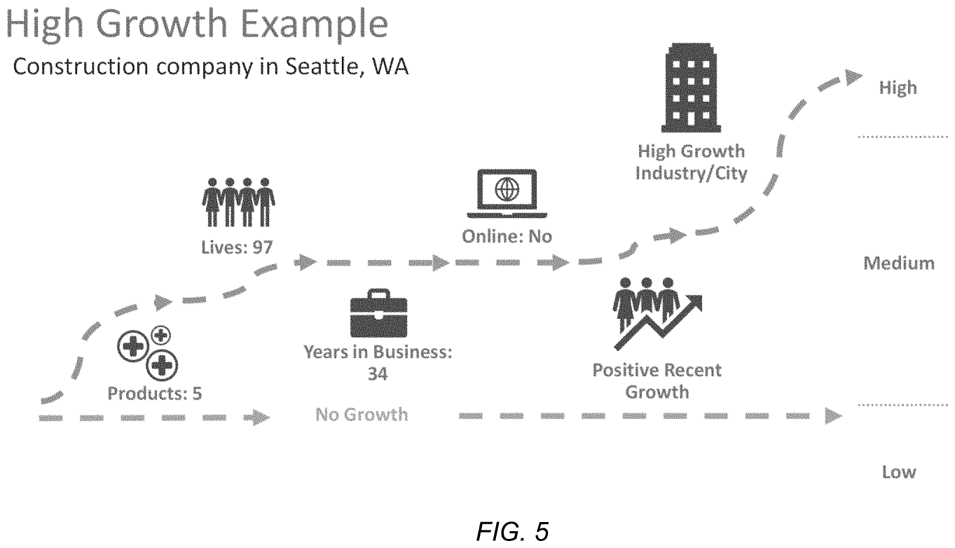

FIG. 5 is a pictorial representation of one example of evaluating projected growth for a specific business. Here, the number of pension and insurance products the company has is 5. The company also has 97 employees. The company has been in business for 34 years. The company does not offer online benefit enrollment. The company has shown positive recent growth and the company is in a high growth industry and city (Greater than 10 percent expected for desired time frame).

| Factor | Value | Flag |
|---|---|---|
| Products | 5 | 2 |
| Lives (Case Size) | 97 | 1 |
| Years in business | 34 | 0 |
| Online enrollment | No | 0 |
| Recent growth | Growth | 1 |
| Forecast growth | >10 | 6 |
| | percent | |
| COMPOSITE | High | 10 |
| SCORE | growth | |

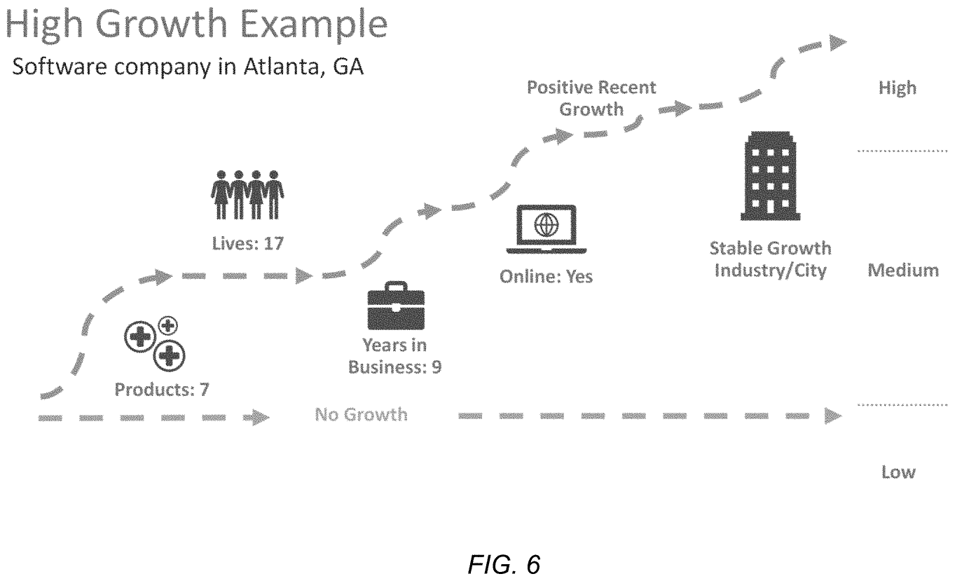

FIG. 6 illustrate is a pictorial representation of one example of evaluating projected growth for another individual business. Here, the number of pension and insurance products the company has is 7. The company has 17 employees. The company has been in business for 9 years. The company offers online benefit enrollment. The company has positive recent growth, and the company is in a stable growth industry and city (5-10 percent growth for the desired time frame).

| Factor | Value | Flag |
|---|---|---|
| Products | 7 | 3 |
| Lives (Case Size) | 17 | 0 |
| Years in business | 9 | 2 |
| Online enrollment | Yes | 2 |
| Recent growth | Growth | 1 |
| Forecast growth | 5-10 | 3 |
| | percent | |
| COMPOSITE | High | 11 |
| SCORE | growth | |

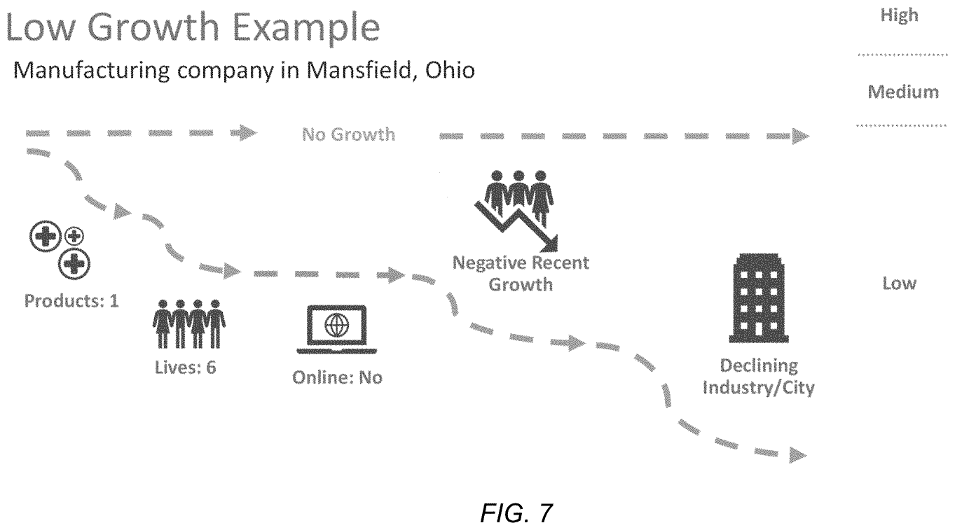

FIG. 7 illustrate is a pictorial representation of one example of evaluating projected growth for another individual business. Here, the number of pension and insurance products the company has is 1. The company has 6 employees. The company has been in business for an unknown number of years as data was not available from the external data source (e.g. Dun & Bradstreet). The company does not have online benefit enrollment. The company has negative recent growth, and the company is in a declining industry and city (declining growth for the desired time frame).

| Factor | Value | Flag |
|---|---|---|
| Products | 1 | −1 |
| Lives (Case Size) | 6 | −1 |
| Years in business | Missing | −1 |
| | (no D&B) | |
| Online enrollment | No | 0 |
| Recent growth | Growth | −1 |
| Forecast growth | Declining | −3 |
| COMPOSITE | No | −7 |
| SCORE | growth | |

Therefore, various embodiments have been shown and described for providing a scoring model and method for individual small and medium businesses to characterize predicted growth of group benefits for each individual business. Although the methodology is shown for group benefits, it is contemplated that it may be extended for ancillary insurance and/or financial products.

Although specific examples have been set forth herein, numerous options, variations, and alternatives are contemplated. For example, other algorithms which may be used in the creation of the employer growth score include random forests, gradient boosting, recurrent neural networks and convolutional neural networks. Various tensors may be used in the vector space that represents the complex interdependencies between various factors and the medium term growth of an employer. It is noted that the weighted-factor approach described herein provided the optimal combination of accuracy and explainability relative to alternatives which were explored.

Other options, variations, and alternatives, may include, for example, different types of models or machine learning models. This may include regression algorithms such as ordinary least squares regression, linear regression, logistic regression, stepwise regression, multivariate adaptive regression splines, and other regression algorithms. Alternatively, this may include other statistical models, neural networks, or other machine learning algorithms or techniques. It is also to be understood, that the particular type of model used may be dependent upon the available data, the processing capability available, the amount of time allotted for processing, the accuracy required for the specific application, and/or other constraints which may be associated with a particular implementation and/or use.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor such as one or more central processing units (CPUs) and/or one or more graphics processing units (GPUs)) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The methods described herein may be incorporated into software in the form of instructions stored on a non-transitory computer readable medium which may be used to perform analysis. Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location. In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. It is to be further understood, that aspects of different embodiments may be combined.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

The invention is not to be limited to the particular embodiments described herein. In particular, the invention contemplates numerous variations. The foregoing description has been presented for purposes of illustration and description. It is not intended to be an exhaustive list or limit any of the invention to the precise forms disclosed. It is contemplated that other alternatives or exemplary aspects are considered included in the invention. The description is merely examples of embodiments, processes, or methods of the invention. It is understood that any other modifications, substitutions, and/or additions can be made, which are within the intended spirit and scope of the invention.

What is claimed is:

1. A method for predicting growth of businesses for group benefits usage comprising:
building a scoring model for use by a computing device by:
identifying a set of variables,
for each of the set of variables assigning a scoring range, the scoring range having a high value and a low value,
for each of the set of variables, identifying segments of scores within the scoring range and a score for each of the segments, and
for each of a plurality of organizations assigning a score for each of the set of variables within the scoring range;
storing in a machine readable memory of the computing device a plurality of instructions for implementing the scoring model;
receiving at the processor of the computing device a plurality of business identifiers, each of the plurality of the business identifiers associated with a different one of a plurality of businesses;
receiving at the processor of the computing device and from at least one external data source connected over a communications network with the computing device, data for populating one or more of the set of variables for each of the plurality of businesses;
receiving at the processor of the computing device and from at least one internal data source in operative communication with the computing device, data for populating one more additional variable within the set of variables for each of the plurality of businesses;
executing the instructions for implementing the scoring model to apply the scoring model to evaluate the plurality of businesses using the processor of the computing device in order to generate the single score indicative of growth for each of the plurality of businesses.

2. The method of claim 1 further comprising generating a display containing the single score indicative of growth for each of the plurality of businesses.

3. The method of claim 1 further comprising segmenting the plurality of businesses based on the single score indicative of growth for each of the plurality of businesses.

4. The method of claim 1 further comprising generating a computer presentation containing the single score indicative of growth for each of the plurality of businesses.

5. The method of claim 1 further comprising ranking each of the plurality of businesses based on the single score indicative of growth.

6. The method of claim 1 wherein the set of variables comprise a first variable for years in business, a second variable for online status of benefits sign-up, a third variable indicative of number of employees, a fourth variable for number of total products, a fifth variable for forecast growth, and a sixth variable for recent employment growth.

7. The method of claim 6 wherein the fifth variable for forecast growth is from the external data source.

8. The method of claim 6 wherein the first variable for years in business is from the external data source.

9. The method of claim 6 wherein the second variable for online status of benefits sign-up is from the internal data source.

10. The method of claim 6 wherein the third variable indicative of number of employees is from the internal data source.

11. The method of claim 6 wherein the fourth variable for number of products is from the internal data source.

12. The method of claim 6 wherein the sixth variable for recent employment growth is from the internal data source.

13. A system for predicting growth of businesses, comprising:
one or more hardware processors configured by machine-readable instructions to:
implement a scoring model, the scoring model constructed by:
identifying a set of variables,
for each of the set of variables assigning a scoring range, the scoring range having a high value and a low value,
for each of the set of variables, identifying segments of scores within the scoring range and a score for each of the segments,
for each of a plurality of organizations assigning a score for each of the set of variables within the scoring range, and
generating a composite score based on the score for each of the set of variables, wherein the composite score combines the score for each of the set of variables into a single score indicative of growth for an individual business;
receive at the one or more hardware processors a plurality of business identifiers, each of the plurality of the business identifiers associated with a different one of a plurality of businesses;
receive at the one or more hardware processors and from at least one external data source connected over a communications network with the one or more hardware processors, data for populating one or more of the set of variables for each of the plurality of businesses;
receive at the one or more hardware processors and from at least one internal data source in operative communication with the one or more hardware processors, data for populating one more additional variable within the set of variables for each of the plurality of businesses; and
apply the scoring model to evaluate the plurality of businesses using the one or more hardware processors in order to generate the single score indicative of growth for each of the plurality of businesses.

14. The system of claim 13 wherein the one or more hardware processors are further configured by the machine-readable instructions to generate a screen display containing the single score indicative of growth for each of the plurality of businesses.

15. The system of claim 13 wherein the one or more hardware processors are further configured by the machine-readable instructions to segment the plurality of businesses based on the single score indicative of growth for each of the plurality of businesses.

16. The system of claim 13 wherein the one or more hardware processors are further configured by the machine-readable instructions to generate a computer presentation containing the single score indicative of growth for each of the plurality of businesses.

17. The system of claim 13 wherein the one or more hardware processors are further configured by the machine-readable instructions to rank each of the plurality of businesses based on the single score indicative of growth.

18. The system of claim 13 wherein the set of variables comprise a first variable for years in business, a second variable for online status of benefits sign-up, a third variable indicative of number of employees, a fourth variable for number of total products, a fifth variable for forecast growth, and a sixth variable for recent employment growth.

19. A method for predicting growth of businesses for group benefits usage, the method comprising:
building a scoring model for use by a computing device by:
identifying a set of variables wherein the set of variables comprise a first variable for years in business, a second variable for online status of benefits sign-up, a third variable indicative of number of employees, a fourth variable for number of total products, a fifth variable for forecast growth, and a sixth variable for recent employment growth,
for each of the set of variables assigning a scoring range, the scoring range having a high value and a low value, wherein the scoring range for the first variable is −1 to 2,
for each of the set of variables, identifying segments of scores within the scoring range and a score for each of the segments, and
for each of a plurality of organizations assigning a score for each of the set of variables within the scoring range;
generating a composite score based on the score for each of the set of variables, wherein the composite score combines the score for each of the set of variables into a single score indicative of growth for an individual business for group benefits usage;
storing in a machine readable memory of the computing device a plurality of instructions for implementing the scoring model;
receiving at the processor of the computing device a plurality of business identifiers, each of the plurality of the business identifiers associated with a different one of a plurality of businesses;
receiving at the processor of the computing device and from at least one external data source connected over a communications network with the computing device, data for populating one or more of the set of variables for each of the plurality of businesses;
receiving at the processor of the computing device and from at least one internal data source in operative communication with the computing device, data for populating one more additional variable within the set of variables for each of the plurality of businesses;
executing the instructions for implementing the scoring model to apply the scoring model to evaluate the plurality of businesses using the processor of the computing device in order to generate the single score indicative of growth for each of the plurality of businesses for group benefits usage.

20. The method of claim 19 wherein at least one of the at least one external data source and the at least on internal data source is in operative communication through an API connection.
